(19) United States
(12) Patent Application Publication
(10) Pub. No.: US 2025/0177223 A1
(43) Pub. Date: Jun. 5, 2025

(54) MOBILE LIFT CHAIR

(71) Applicant: David Patiño, Hollywood, FL (US)

(72) Inventor: David Patiño, Hollywood, FL (US)

(21) Appl. No.: 18/529,974

(22) Filed: Dec. 5, 2023

(51) Int. Cl. A61G 5/14; A61G 5/10

(52) U.S. Cl. CPC A61G 5/14; A61G 5/1067; A61G 5/1089

(57) ABSTRACT

A mobile lift chair includes a set of wheels, a frame supported by the set of wheels, a seat supported by the frame, and a seat lift/stabilizer assembly supported by the frame and the seat, where the seat lift/stabilizer assembly has a retracted configuration, where the set of wheels allow the frame to move laterally across a ground surface and a sitting area of the seat is substantially parallel to the ground surface and an extended configuration, where a portion of the lift/stabilizer assembly contacts the ground surface and prevents the set of wheels from allowing the frame to move laterally across a ground surface and the sitting area of the seat is substantially non-parallel to the ground surface.

### FIELD OF THE INVENTION

The present invention relates generally to lift chairs, and, more particularly, relates to a chair that is mobile and automatically stabilizes itself when lifting or lowering is in progress.

### BACKGROUND OF THE INVENTION

Lift chairs, also known as power lift recliners or lift recliner chairs, are specialized pieces of furniture designed to assist senior citizens and individuals with mobility issues in standing up and sitting down comfortably. The primary feature of a lift chair is its built-in electric or hydraulic lift mechanism, which gently tilts the chair forward, helping the user transition from a seated to a standing position or vice versa. This can greatly aid seniors who may have difficulty standing up from a regular chair due to weak muscles, joint pain, or other mobility issues.

Prior-art lift chairs are stationary, i.e., they remain in one location on a floor. They rely on motors that receive power from standard plug-in wall outlets near the chair. If a user wants to or needs to be transported, he or she needs to be removed from the lift chair and transferred to a chair with wheels (wheelchair). Wheelchairs are mobility devices designed to assist individuals with limited mobility, whether due to disability, injury, illness, or age. They offer a means of transportation and independence for people who cannot walk or have difficulty walking.

Wheelchair frames are typically made of lightweight materials like aluminum or steel to make them easy to maneuver and transport. Some advanced models use materials like titanium or carbon fiber for even lighter weight and increased durability. Wheelchairs have four wheels, with the larger rear wheels allowing for self-propulsion by the user's own arm strength. The front wheels, called casters, are smaller and swivel to provide maneuverability. Some individuals may require assistance from a caregiver, while others may have wheelchairs with power-assisted wheels or even fully electric wheelchairs for greater independence.

The seating area of a wheelchair typically consists of a seat and a backrest. These components are pure basic structures that maintain the seating position only and causes poor posture and increases pressure points. Wheelchairs often have armrests on either side of the seat to provide support and a place to rest the user's arms. Some models have flip-back or removable armrests to facilitate easier transfers in and out of the chair. Footrests or leg rests (often removable) accommodate the user's needs and provide leg support. Some models also offer elevating leg rests for users with specific medical requirements.

To facilitate safe transitions of the user into and out of the chair, most, if not all, wheelchairs are equipped with manual brakes, usually located on the rear wheels. These brakes allow the user or a caregiver to secure the rear wheels in place, thus securing the entire wheelchair in place when needed.

Some parties have attempted to combine the benefits of lift chairs and the mobility of a wheel chairs. For example, U.S. Pat. No. 6,454,285 to Koenig (hereinafter “Koenig”) discloses a chair with wheels that can move a patient from one location to another. The Koenig chair has a both a lift mechanism and a chair tilt mechanism. When one moves a lever, the back wheels of the chair are lifted off the ground, thereby leaving the chair frame on the floor, which is meant to stabilize the chair and preventing it from rolling. Further movement of the lever causes the back portion of the seat to lift upward, assisting the patient out of the seat. Due to the location of the lever and forces required, this chair requires manual manipulation from someone other than the person sitting in the chair. If someone were to sit in the elevated/tilted seat without supervision, the force on the seat could easily cause the seat to drop back to a horizontal position, which would return the back wheels into contact with the ground surface and result in the chair unintendedly rolling away from the location it is supposed to remain. This has the potential to cause harm to the user. It is often impractical to have an attendant present every time one wants to enter or exit a chair, thus, this chair has disadvantages.

U.S. Patent Pub. No. 2021/0145675 by Dowding (hereinafter “Dowding”) teaches a wheelchair that, like Koenig, has a frame that causes the back wheels to lift off of the ground. As they do so, the seat rises in height with the wheels. With Dowding, the sitting portion of the seat remains horizontal the entire time. With both Dowding and Koenig, a part of the frame replaces the wheels. That is, the frame comes down to meet the ground and the wheels move upward away from the ground. In each of these devices, if the ground is not stable, e.g., if an object were on one side of the frame, the lifting movement would cause the chair to tilt to the side and fall over. In addition, it takes a tremendous amount of energy to lift the entire seat in Dowding.

Several other prior art designs have chairs with wheels and that lift the user, but each requires wheels that lock, which necessitates special locking hardware and/or wheels that introduces cost, failure points, and in some of these designs, the need for the user to remember to engage and disengage the lock.

Therefore, a need exists to overcome the problems with the prior art as discussed above.

### SUMMARY OF THE INVENTION

The invention provides a mobile lift chair that overcomes the hereinafore-mentioned disadvantages of the heretofore-known devices and methods of this general type and that provides a chair with both lift capabilities as well as mobility features.

With the foregoing and other objects in view, there is provided, in accordance with the invention, a mobile lift chair that has a frame, a set of wheels coupled to the frame and supporting the frame above a ground surface, a seat supported by the frame and having at least a portion that is vertically movable with reference to the set of wheels, and a seat lift/stabilizer assembly that has a stabilizer foot movably coupled to the frame, a seat lifting member coupled to the stabilizer foot and the seat, and an actuator that selectively places the seat lifting member in a retracted configuration, where the foot is not in contact with the ground surface and the seat is in a resting position and an extended configuration, where the foot is in contact with the ground surface and the seat is in a lifted position.

In accordance with another feature, the seat lifting member includes a telescoping member.

In accordance with a further feature of the present invention, the set of wheels is at least four wheels.

In accordance with a further feature of the present invention, when the seat lifting member is in the retracted configuration, the set of wheels allow the mobile lift chair to move laterally along the ground surface.

In accordance with the present invention, the stabilizer foot is pivotably coupled to the frame and the stabilizer foot has a first end coupled to the frame and a second end with a friction surface and being movable between a first position that is between the ground surface and the seat and a second position that places the friction surface in contact with the ground surface.

In accordance with yet another feature of the present invention, the seat includes a sitting surface where, in the resting configuration, the sitting surface is substantially horizontal and, in the lifted configuration, the sitting surface is substantially non-horizontal.

In accordance with an additional feature of the present invention, the actuator includes an electric motor, which may be battery powered or powered from plugging into a wall or other power source.

In accordance with one more feature of the present invention, in the extended configuration, the set of wheels and stabilizer foot make contact with the ground surface and no part of the frame makes contact with the ground surface.

In accordance with another feature, an embodiment of the present invention includes a set of wheels, a frame supported by the set of wheels, a seat supported by the frame, and a seat lift/stabilizer assembly supported by the frame and the seat. The seat lift/stabilizer assembly has a retracted configuration, where the set of wheels allow the frame to move laterally across a ground surface and a sitting area of the seat is substantially parallel to the ground surface and an extended configuration, where a portion of the lift/stabilizer assembly contacts the ground surface and prevents the set of wheels from allowing the frame to move laterally across a ground surface and the sitting area of the seat is substantially non-parallel to the ground surface.

In accordance with an additional feature, the seat lift/stabilizing assembly has a telescoping member.

In accordance with another feature, the seat lift/stabilizing assembly includes a stabilizer foot pivotably coupled to the frame and the stabilizer foot can have a first end coupled to the frame and a second end having a friction surface and being movable between a first position that is between the ground surface and the seat and a second position that places the friction surface in contact with the ground surface.

In accordance with a further feature of the present invention, the seat lift/stabilizer assembly has a battery powered motor.

In accordance with yet another feature, an embodiment of the present invention includes a method for stabilizing a mobile lift chair that includes a first step of providing a set of wheels, a frame supported by the set of wheels, a seat supported by the frame, and a seat lift/stabilizer assembly supported by the frame and the seat, where the seat lift/stabilizer assembly has a retracted configuration, where the set of wheels allow the frame to move laterally across a ground surface and a sitting area of the seat is substantially parallel to the ground surface and an extended configuration, where a portion of the lift/stabilizer assembly contacts the ground surface and prevents the set of wheels from allowing the frame to move laterally across a ground surface and the sitting area of the seat is substantially non-parallel to the ground surface. In a second step, the seat lift/stabilizer assembly is placed in the retracted configuration. In a further step, the mobile lift chair is moved laterally across the ground surface via the set of wheels. In another step, the seat lift/stabilizer assembly is placed in the extended configuration to substantially simultaneously stabilize the mobile lift chair in a single location along the ground surface and lift at least a portion of the seat in a direction away from the ground surface.

In accordance with a further feature of the present invention, an additional step includes placing a user in the seat prior to the moving step and assisting the user out of the seat by placing the lift/stabilizer assembly in the extended configuration.

In accordance with another feature of the present invention, the seat lift/stabilizing assembly includes a stabilizer foot pivotably coupled to the frame.

In accordance with yet another feature of the present invention, the stabilizer foot includes a first end coupled to the frame and a second end having a friction surface and being movable between a first position that is between the ground surface and the seat and a second position that places the friction surface in contact with the ground surface.

Although the invention is illustrated and described herein as embodied in a mobile lift chair, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up,” “down,” “left,” “right,” “inside,” “outside,” “front,” “back,” “distal,” “proximal” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed,” “coupled,” “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the structure being referenced. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective downward-looking right-side view of a mobile lift chair in accordance with an embodiment of the present invention;

FIG. 2 is a perspective left-side rear view of the frame and wheels of the chair in FIG. 1, in accordance with the present invention;

FIG. 3 is a perspective downward-looking rear view of the frame, wheels, and stabilizer foot of FIG. 2, in accordance with the present invention;

FIG. 4 is a close-up view of the seat lift/stabilizer assembly of the chair in FIG. 1, in accordance with the present invention;

FIG. 5 is an elevational left-side view of the mobile lift chair of FIG. 1 in the first stage of transitioning from a retracted configuration to an expanded configuration, in accordance with the present invention;

FIG. 6 is an elevational left-side view of the mobile lift chair of FIG. 1 in the second stage of transitioning from a retracted configuration to an expanded configuration, in accordance with the present invention;

FIG. 7 is an is an elevational left-side view of the mobile lift chair of FIG. 1 in the last stage of transitioning from a retracted configuration to an expanded configuration, in accordance with the present invention; and

FIG. 8 is a process flow diagram illustrating a process of the mobile lift chair of FIG. 1 transitioning from the retracted configuration to the expanded configuration and back to the retracted configuration, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient chair with wheels that allows a user to move from one location to another and also has lift capabilities that assist the user to go from a sitting to a standing position or from a standing to a sitting position. Embodiments of the invention provide stabilizing feature facilitated by a seat lift/stabilizer assembly that includes a stabilizer foot that contacts a ground surface and prevents the chair from moving while the user is transitioning from a sitting to a standing position or vice versa.

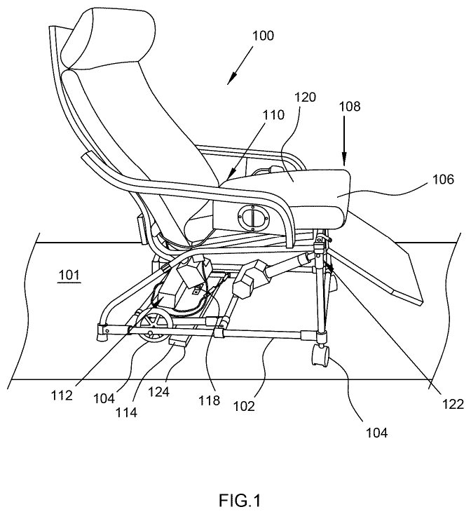

Referring now to FIG. 1, one embodiment of the present invention is shown in a perspective right-side view. FIG. 1 shows several advantageous features of the present invention but, as will be described below, the invention can be provided in several shapes, sizes, combinations of features and components, and varying numbers and functions of the components. The first example of a mobile lift chair 100, as shown in FIG. 1, includes a frame 102, a set of wheels 104 coupled to the frame 102. The frame 102 can be any rigid structure that supports certain physical elements of the chair 100. In a preferred embodiment, the frame 102 is made of aluminum, but it can be made of many other materials, such as steel, plastic, carbon fiber, and the like. The set of wheels 104 supports the frame above a ground surface 101. The set of wheels 104, in one embodiment, is a set of four wheels, i.e., one at each corner of the frame 102. In one embodiment, the rear wheels are fixed and only roll in one vector, while the front wheels are able to rotate 360° around a pivot axis, for example, casters, which allow the chair to be steered in any direction. This wheel system is commonly seen in standard wheelchairs, but the rear wheels are generally much larger in standard wheelchairs. The present invention is in no way limited to the type and size of wheels shown in FIG. 1.

A seat 106 is supported by the frame 102, i.e., rests upon, and has a distal (front) portion 108 coupled to the frame 102 at a frame portion 122. The seat 106 has a proximal (back) portion 110 that is vertically movable with reference to the set of wheels 104, i.e., up and down. More specifically, the distal (front) portion 108 of the seat 106 is pivotally attached to the frame at frame portion 122. The proximal (back) portion 110 is able to be moved in an upward direction, with reference to the wheels 104 on the ground surface 101. This lifting of the proximal portion 110 of the seat 106 tilts the seat 106 in a downward direction, which assists a person in the seat with moving from a sitting to a standing position or vice versa.

The seat 106 also has a sitting surface 120 where the majority of a user's weight will be placed when the seat 106 is being used. The mobile lift chair 100 also includes a seat lift/stabilizer assembly 112 that has a stabilizer foot 114 movably coupled to the frame 102. As will be described below and shown in subsequent figures, the stabilizer foot 114 includes a frictional surface 124 that makes contact with the ground surface 101 and provides a frictional resistance that prevents the mobile lift chair 100 from moving along the ground surface 101 while the stabilizer foot 114 is in contact with the ground surface 101.

The seat lift/stabilizer assembly 112 also includes a seat lifting member 114 that is mechanically coupled to the stabilizer foot 114 and the seat 106 via an actuator 118. The actuator 118 can be battery powered and selectively places the seat lifting member 114 in various positions. One such position results when the seat lift/stabilizer assembly 112 is in a retracted configuration, as is shown in FIG. 1. In this retracted configuration, the stabilizer foot 114 is not in contact with the ground surface 101. More specifically, the stabilizer foot 114 is stored inside or directly adjacent the frame, i.e., further from the ground surface 101 than the point where the wheels 104 make contact with the ground surface 101.

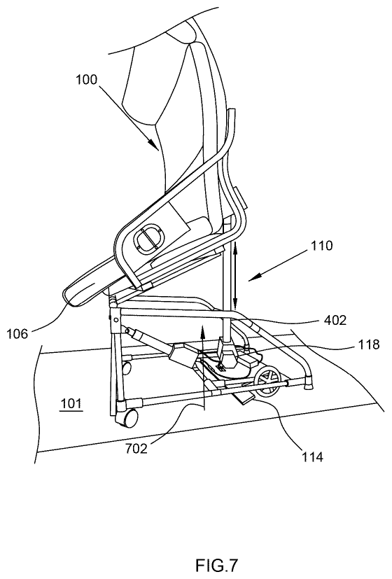

In this position, the seat 106 is in a resting position, where a user can sit comfortably in the seat 106, i.e., the portion of the seat 120 is substantially horizontal/parallel to the ground surface 101. The seat lift/stabilizer assembly 112 also has an extended configuration, where the stabilizer foot 114 is in contact with the ground surface 101 and the seat 106 is in a lifted position. This configuration is show in FIG. 7.

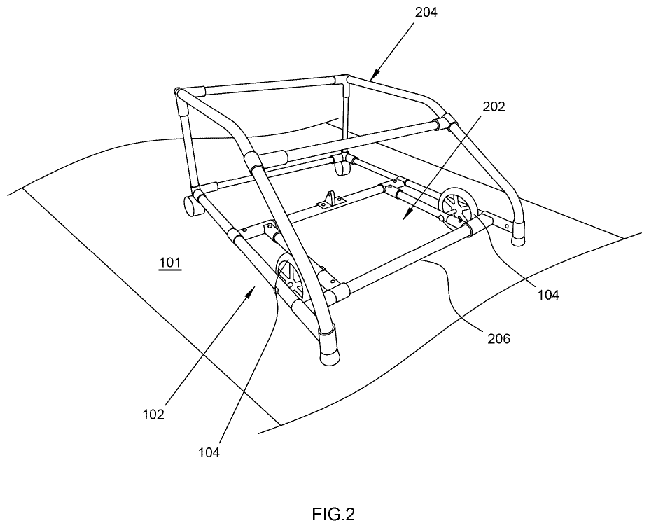

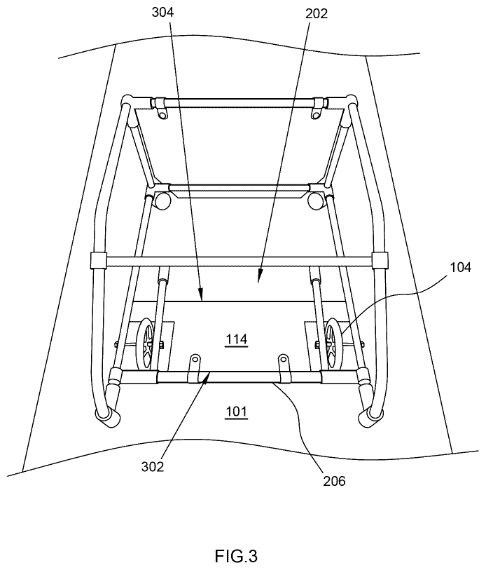

FIG. 2 shows a perspective right-side rear view of the frame 102. The frame 102 includes an upper portion 204 where the seat 106 (not shown in this view) attaches and is supported by the frame 102. The frame 102 also includes a foot area 202 where the stabilizer foot 114 (not shown in this view) resides. The stabilizer foot 114 is pivotably attached to a frame bar 206, as will be shown in FIG. 3. This view (FIG. 2) also shows the wheels 104 where the rear wheels are solidly affixed to the frame and can only role in one dimension and the front wheels are depicted as casters that can rotate 360° and provide steering for the frame 102.

FIG. 3 provides a perspective rear downward-looking view of the frame 102, including the stabilizer foot 114. In this view, the seat 106 and actuator 118 are removed from the frame 102 allowing the stabilizer foot 114 to be seen residing in the foot area 202. The stabilizer foot 114 is coupled at one end 302 to the frame bar 206. The other end 304 is free to move as the first end 302 pivots around the frame bar 206. In a lowered position, the second end 304 of the stabilizer foot 114 will make contact with the ground surface 101 and prevent the chair 100 from moving along the ground surface 101. In an up position, the stabilizer foot 114 does not touch the ground surface 101 and does not interfere with the free rolling of the wheels 104 along the ground surface 101.

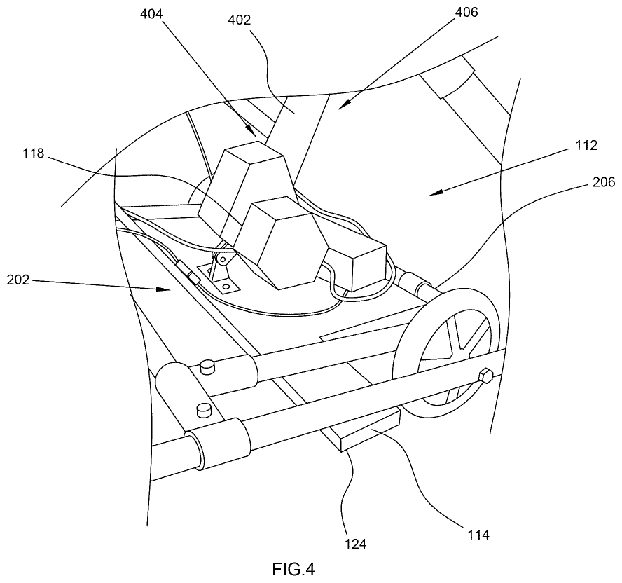

FIG. 4 provides a close up perspective left-side view of the entire seat lift/stabilizer assembly 112, including the actuator 118, which is attached to and sits atop of the stabilizer foot 114. In this view, the frictional surface 124 can be seen extending below the stabilizer foot 114. The actuator 118 includes a seat lifting member 402 that has a first end 404 that is attached to and controlled by the actuator 118. The second end 406 of the seat lifting member 402 is attached to the proximal (back) portion 110 of the seat 106. In one embodiment, the seat lifting member 402 is a telescoping element that extends and contracts on demand by the actuator 118.

Referring back to FIG. 1, the proximal (back) portion 110 of the seat 106 is shown in its nested position. That is, the proximal (back) portion 110 of the seat 106 is resting on the frame 102 and the frame 102 prevents it from moving any further down, i.e., closer to the ground surface 101. Also shown in FIG. 1, the actuator 118 has caused the seat lifting member 402 (not visible in FIG. 1) to retract. This is evidenced by the fact that the stabilizer foot 114 is lifted off of the ground surface 101. In other words, when the actuator 118 causes the seat lifting member 402 to retract, it pulls the seat 106 downward and, when the seat cannot move further downward (because the frame 102 prevents it from doing so), the retracting seat lifting member 402 then pulls the actuator 118 and stabilizer foot 114 upwards, thereby lifting the stabilizer foot 114 off of the ground surface 101. When the seat lifting member 402 is in this retracted configuration, the set of wheels 104 allows the mobile lift chair 100 to move laterally along the ground surface 101. When the seat lifting member 402 extends, the opposite takes place, and the stabilizer foot 114 prevents the mobile lift chair 100 from moving laterally along the ground surface 101.

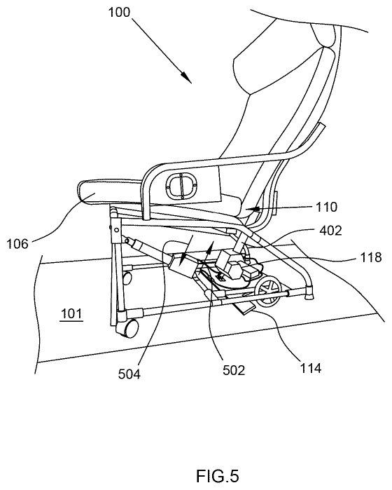

Referring now to FIG. 5, the chair 100 is shown in an elevational left-side view. In this figure, the actuator 118 has caused the seat lifting member 402 to begin extending in the direction shown by arrow 502. In this first step, as the seat lifting member 402 begins extending in the direction shown by arrow 502, an opposite force 504 (indicated by the arrow) is applied to the seat lifting member 402 by the weight of the seat 106. The force 504 applied by the weight of the seat 106 causes the actuator 118 to push the stabilizer foot 114 downward towards the ground surface 101, as shown in FIG. 5.

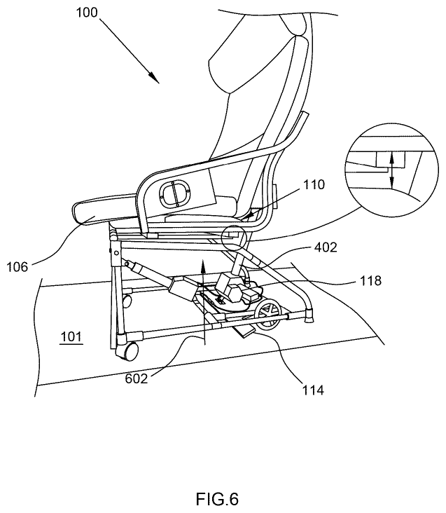

FIG. 6 shows what happens when the actuator 118 causes the seat lifting member 402 to continue extending after the stabilizer foot 114 has made solid contact with the ground surface 101. That is, once the actuator 118 and stabilizer foot 114 cannot move downward any further, the ground surface 101 applies an upward force 602 to the entire seat lift/stabilizer assembly 112. This force 602 overcomes the weight of the seat 106 (empty or with a person therein) and causes the seat 106 to raise, at least in the proximal portion 110 thereof. As the seat 106 raises, the seat lift/stabilizer assembly 112 advantageously keeps the stabilizer foot 114 in solid contact with the ground surface 101, which prevents the chair 100 from moving laterally along the ground surface 101 in any direction.

FIG. 7 shows the chair 100 with the seat lifting member 402 at its maximum extension. In this position, the proximal portion 110 of the seat 106 has risen with reference to the ground surface 101, while the distal front portion 108 of the seat 106 retains connection with the frame 102. In this position, a user of the chair is greatly assisted in transitioning from a sitting to a standing position or from a standing to a sitting position. This is of great advantage to a number of people, for example, elderly people or people with physical conditions that render normal activities more difficult for them than for others.

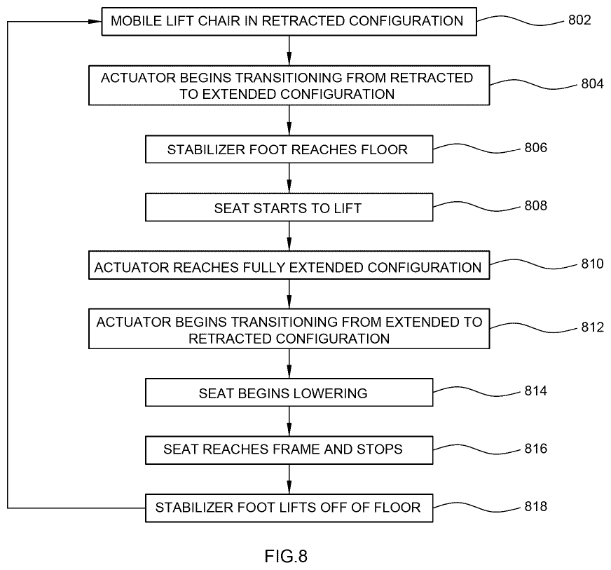

FIGS. 1-7 will be described in conjunction with the process flow chart of FIG. 8. Although FIG. 8 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 8 for the sake of brevity. In some embodiments, some or all of the process steps included in FIG. 8 can be combined into a single process.

With reference now to the top of FIG. 8, the process starts at step 802 with the mobile lift chair 100 in the retracted configuration shown in FIG. 1. More specifically, the seat lift/stabilizer assembly 112 is in its retracted configuration, where the actuator 118 has the seat lifting member 402 retracted sufficient to lift the stabilizer foot 114 off of the ground surface 101 and the seat 106 is in the resting position shown in FIGS. 1 and 5. In this position, the mobile lift chair 100 is laterally movable across the ground surface 101 via the set of wheels 104. A user simply needs to assert a force on the chair, which can be manually or mechanically assisted.

In step 804, the actuator 118 is engaged and begins transitioning from the retracted configuration to the extended configuration. This is illustrated in FIG. 5. Here, the actuator 118 has caused the seat lifting member 402 to partially extend. The stabilizer foot 114, which is pivotably coupled to the frame 102, due to forces applied by the seat 106 through the seat lifting member 402 and actuator 118, comes into contact with the ground surface 101 in step 806. With the stabilizer foot 114 making contact with the ground surface 101, in step 808, the proximal portion 110 of the seat 106 starts to lift upward away from the frame 102. In step 810, the seat lifting member 402 reaches its fully extended configuration where the sitting surface of the seat 106 has transitioned from the resting (substantially horizontal) configuration shown in FIG. 1 to the lifted (substantially non-horizontal) configuration shown in FIG. 7. It is at this point that a user can either exit the seat, if they were already sitting in it, or they can place themselves in the seat if it is unoccupied.

In step 812, the actuator 118 is reversed, allowing the seat 106 to begin lowering toward the frame 102 in step 814. In step 816 the seat reaches its resting configuration shown in FIG. 5, with the stabilizer foot 114 still on the ground surface 101. In step 818, after the seat is in the resting configuration on the frame 102, the retraction of the seat lifting member 402 applies an upward force on the stabilizer foot 114 and lifts it off of the ground surface 101. The process then moves back to step 802 where it repeats.

A mobile lifting chair has been disclosed that has a lift/stabilizing assembly that automatically stabilizes the lifting chair while it is lifted to assist the user while entering or existing the chair. When the chair is retracted, the user can sit comfortably and the wheels allow the chair to be easily transported across a ground surface. The chair/recliner is by design supportive of the spine's natural curve while reducing pressure points-better circulation throughout the lower body.

The claims appended hereto are meant to cover all modifications and changes within the scope and spirit of the present invention.

What is claimed is:

1. A mobile lift chair comprising:
a frame;
a set of wheels coupled to the frame and supporting the frame above a ground surface;
a seat supported by the frame and having at least a portion that is vertically movable with reference to the set of wheels; and
a seat lift/stabilizer assembly having:
a stabilizer foot movably coupled to the frame;
a seat lifting member coupled to the stabilizer foot and the seat; and
an actuator that selectively places the seat lifting member in:
a retracted configuration, where the stabilizer foot is not in contact with the ground surface and the seat is in a resting position; and
an extended configuration, where the stabilizer foot is in contact with the ground surface and the seat is in a lifted position.

2. The mobile lift chair according to claim 1, wherein the seat lifting member comprises:
a telescoping member.

3. The mobile lift chair according to claim 1, wherein the stabilizer foot is pivotably coupled to the frame.

4. The mobile lift chair according to claim 1, wherein the set of wheels is at least four wheels.

5. The mobile lift chair according to claim 1, wherein:
when the seat lifting member is in the retracted configuration, the set of wheels allow the mobile lift chair to move laterally along the ground surface.

6. The mobile lift chair according to claim 1, wherein the stabilizer foot comprises:
a first end coupled to the frame; and
a second end having a friction surface and being movable between a first position that is between the ground surface and the seat and a second position that places the friction surface in contact with the ground surface.

7. The mobile lift chair according to claim 1, wherein the seat comprises:
a sitting surface wherein:
in the resting position, the sitting surface is substantially horizontal; and
in the lifted position, the sitting surface is substantially non-horizontal.

8. The mobile lift chair according to claim 1, wherein the actuator comprises:
an electric motor.

9. The mobile lift chair according to claim 8, wherein:
the electric motor is battery powered.

10. The mobile lift chair according to claim 8, wherein:
in the extended configuration, the set of wheels and stabilizer foot make contact with the ground surface and no part of the frame makes contact with the ground surface.

11. A mobile lift chair comprising:
a set of wheels;
a frame supported by the set of wheels;
a seat supported by the frame; and
a seat lift/stabilizer assembly supported by the frame and the seat, the seat lift/stabilizer assembly having:
a retracted configuration, where the set of wheels allow the frame to move laterally across a ground surface and a sitting area of the seat is substantially parallel to the ground surface; and
an extended configuration, where a portion of the seat lift/stabilizer assembly contacts the ground surface and prevents the set of wheels from allowing the frame to move laterally across a ground surface and the sitting area of the seat is substantially non-parallel to the ground surface.

12. The mobile lift chair according to claim 11, wherein the seat lift/stabilizing assembly comprises:
a telescoping member.

13. The mobile lift chair according to claim 11, wherein the seat lift/stabilizing assembly comprises:
a stabilizer foot pivotably coupled to the frame.

14. The mobile lift chair according to claim 13, wherein the stabilizer foot comprises:
a first end coupled to the frame; and
a second end having a friction surface and being movable between a first position that is between the ground surface and the seat and a second position that places the friction surface in contact with the ground surface.

15. The mobile lift chair according to claim 11, wherein the seat lift/stabilizer assembly comprises:
a battery powered motor.

16. A method for stabilizing a mobile lift chair, the method comprising:
providing:
a set of wheels;
a frame supported by the set of wheels;
a seat supported by the frame; and
a seat lift/stabilizer assembly supported by the frame and the seat, the seat lift/stabilizer assembly having:
a retracted configuration, where the set of wheels allow the frame to move laterally across a ground surface and a sitting area of the seat is substantially parallel to the ground surface; and
an extended configuration, where a portion of the seat lift/stabilizer assembly contacts the ground surface and prevents the set of wheels from allowing the frame to move laterally across a ground surface and the sitting area of the seat is substantially non-parallel to the ground surface.
placing the seat lift/stabilizer assembly in the retracted configuration;
moving the mobile lift chair laterally across the ground surface via the set of wheels; and
placing the seat lift/stabilizer assembly in the extended configuration to substantially simultaneously stabilize the mobile lift chair in a single location along the ground surface and lift at least a portion of the seat in a direction away from the ground surface.

17. The method according to claim 16, further comprising:
placing a user in the seat prior to the moving step; and
assisting the user out of the seat by placing the seat lift/stabilizer assembly in the extended configuration.

18. The method according to claim 16, wherein the seat lift/stabilizing assembly comprises:
a telescoping member.

19. The method according to claim 16, wherein the seat lift/stabilizing assembly comprises:
a stabilizer foot pivotably coupled to the frame.

20. The method according to claim 19, wherein the stabilizer foot comprises:
a first end coupled to the frame; and
a second end having a friction surface and being movable between a first position that is between the ground surface and the seat and a second position that places the friction surface in contact with the ground surface.
